(19) United States
(12) Patent Application Publication
(10) Pub. No.: US 2025/0024987 A1
(43) Pub. Date: Jan. 23, 2025

(54) AUTOMATIC WATER FILLING FOR CONNECTED SMALL APPLIANCE

(71) Applicant: Haier US Appliance Solutions, Inc., Wilmington, DE (US)

(72) Inventors: Janghwan Hahn, Louisville, KY (US); Anand Ashok Bora, Louisville, KY (US)

(21) Appl. No.: 18/353,726

(22) Filed: Jul. 17, 2023

(51) Int. Cl. A47J 31/52; A47J 31/44; F25D 23/12; F25D 29/00

(52) U.S. Cl. CPC A47J 31/525; A47J 31/4457; F25D 23/126; F25D 29/00

(57) ABSTRACT

A kitchen appliance and a refrigerator appliance are commissioned on the same user account, the refrigerator appliance configured with a water dispensing system. The kitchen appliance monitors the water volume of a removable water container. If the level of water in the container is below a prescribed level, the kitchen appliance alerts a user and identifies the connected refrigerator appliance. When the water container is removed from the kitchen appliance, the kitchen appliance determines a refill volume to return the water container to a predetermined level and communicates the refill volume to the water dispensing system. The water dispensing system is preset to dispense the refill volume on the next activation of the dispensing system.

### FIELD OF THE INVENTION

The present disclosure relates generally to connected kitchen appliances, more specifically to small kitchen appliances and refrigerators commissioned under the same account.

### BACKGROUND OF THE INVENTION

Known kitchen appliances, such as coffee makers, espresso machines, and ice makers, require a water container to be periodically filled by a user. Typically, a user is required to remove the water container from the appliance and to dispense water into the container to bring the water level up to a level marked on the container. In many cases, filtered water, such as from a water dispenser on a refrigerator, is used. Too much or too little water in the container may cause user dissatisfaction with spills or frequent refilling of the container.

In many cases, the marked level on the container is difficult to identify, particularly when using the water dispenser on a refrigerator. Users may find refilling to the marked level requires constant attention and unnecessary starts and stops to achieve the desired level, leading to further user dissatisfaction.

Accordingly, an improvement in water filling for kitchen appliances may be desirable.

### BRIEF DESCRIPTION OF THE INVENTION

Aspects and advantages of the invention will be set forth in part in the following description, may be apparent from the description, or may be learned through practice of the invention.

In one exemplary aspect, a kitchen appliance and a refrigerator appliance commissioned on the same user account is provided. The refrigerator appliance comprises a water dispensing system, a removable water container defining a maximum fluid level, a presence detector for the water container, a fluid level sensor configured to detect a fluid level in the water container, and an appliance controller in operative communication with the presence detector and the fluid level sensor. The appliance controller is configured to monitor a fluid level in the water container using the fluid level sensor, detect removal of the water container using the presence detector, determine a refill volume to return the fluid level in the water container to a prescribed fluid level, and communicate the refill volume to the water dispensing system of the refrigerator appliance.

In another exemplary aspect, a method of operating a kitchen appliance and a refrigerator appliance from a network is provided. The method comprises receiving notification from a fluid level sensor on a kitchen appliance of a low fluid level, receive notification from a presence detector on the kitchen appliance of a removal of a water container from the kitchen appliance, receive from the kitchen appliance a refill volume to return the water container to a predetermined fluid level, identify a refrigerator appliance from one or more refrigerator appliances commissioned on a same user account as the kitchen appliance, and communicate the refill volume to a water dispensing system of the refrigerator appliance.

In another exemplary aspect, a method of operating a kitchen appliance commissioned on the same user account with a refrigerator appliance is provided. The refrigerator appliance comprises a water dispensing system, the kitchen appliance comprising a removable water container defining a maximum fluid level, a presence detector for the water container, and a fluid level sensor configured to detect a fluid level in the water container. The method comprises monitoring a fluid level in the water container using the fluid level sensor, detecting removal of the water container using the presence detector, determining a refill volume to return the fluid level in the water container to a prescribed fluid level, and communicating the refill volume to the water dispensing system of the refrigerator appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a kitchen appliance and a connected refrigerator appliance commissioned on the same user account in accordance with an embodiment of the present disclosure;

FIG. 2 represents an exemplary kitchen appliance in accordance with an embodiment of the present disclosure;

FIG. 3 represents an enlarged view of the kitchen appliance of FIG. 2 showing details of the water container;

FIG. 4 represents a front view of a refrigerator appliance in accordance with an embodiment of the present disclosure; and

FIG. 5 illustrates a method for operating a kitchen appliance in accordance with an embodiment of the present disclosure.

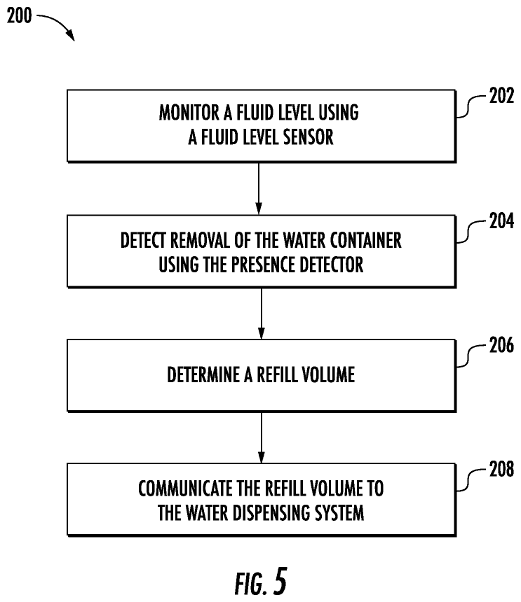

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

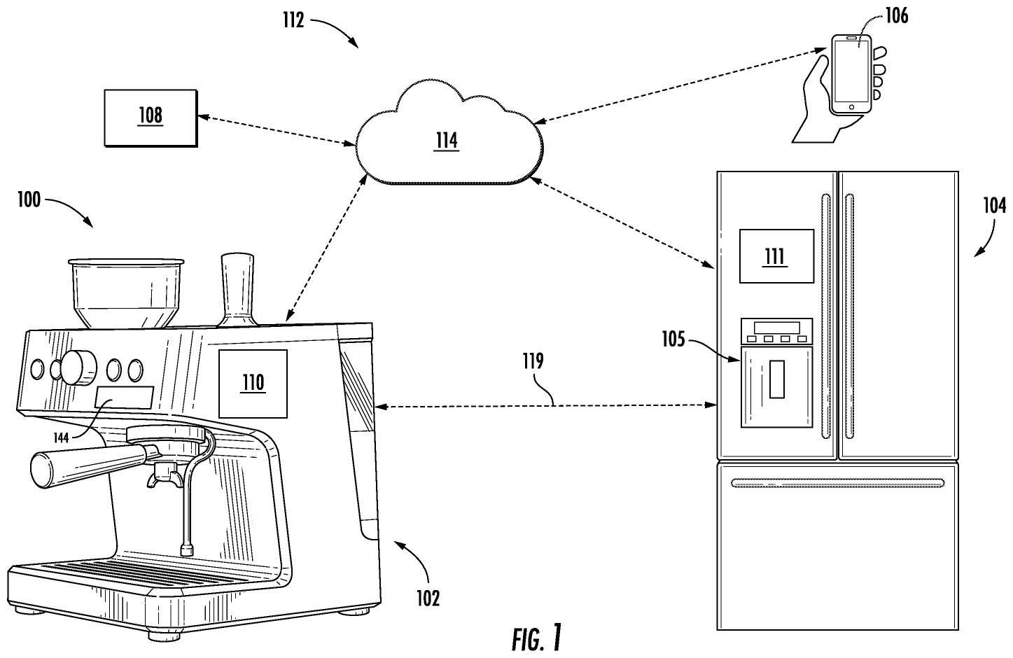

Turning to the figures, FIG. 1 provides a system of connected home appliances commissioned on the same user account (i.e., “connected home appliances 100”) in accordance with embodiments of the present disclosure. In general, a system of connected appliances 100 may include any suitable number, type, and configuration of appliances, remote servers, network devices, and/or other external devices that are able to communicate with each other or are otherwise interconnected. This interconnection, interlinking, and interoperability of multiple appliances and/or devices may commonly be referred to as “smart home” or “connected home” appliance interconnectivity.

This communication may be achieved using any suitable communication protocols and interfaces, such as one or more wireless networks, to transfer useful information or data. For example, interconnected appliances may share consumer usage data, user preferences, appliance operating parameters, operating conditions, and/or other useful data or information. Sharing data between and among various appliances or other devices within the system of connected appliances 100 may result in improved overall system operation, including improved efficiency and performance of each appliance individually and/or all appliances collectively. In addition, user interaction, monitoring, control, and overall satisfaction with the system of connected appliances 100 may be enhanced. Communication between appliances commissioned on the same user account may be established directly between the appliances (i.e., direct communication link 119) or through a network 114 within an external communication system.

FIG. 1 illustrates a system of connected devices 100 provisioned on the same user account according to exemplary embodiments of the present subject matter. As shown, system of connected devices 100 generally includes a kitchen appliance 102 (e.g., illustrated herein as a brewed beverage maker, such as an espresso machine) and a refrigerator appliance 104 (e.g., illustrated herein as a refrigerator having an in-door water/ice dispenser, dispensing system 105). Each of the kitchen appliance 102 and the refrigerator appliance 104 will be described below according to exemplary embodiments of the present subject matter. However, it should be appreciated that the specific appliance types and configurations are only exemplary and are provided to facilitate discussion regarding the use and operation of an exemplary system of connected devices 100.

For example, the system of connected appliances 100 may include any suitable number and type of “appliances,” such as “household appliances.” These terms are used herein to describe appliances typically used or intended for common domestic tasks. The scope of the present subject matter includes an appliance that consumes water and an appliance that can provide water but not supply water directly to the consuming appliance. However, the disclosure is not limited to the number, type, and configurations of appliances set forth herein. Moreover, although only two appliances are illustrated, various embodiments of the present subject matter may also include three or more appliances, each of which may transmit, receive, and/or relay signals among connected appliances and/or other external devices.

In addition, it should be appreciated that system of connected appliances 100 may include one or more external devices, e.g., devices that are separate from or external to the one or more appliances, and which may be configured for facilitating communications with various appliances or other devices. For example, according to exemplary embodiments of the present subject matter, the system of connected appliances 100 may include or be communicatively coupled with an external device 106 that may be configured to enable user interaction with some or all appliances or other devices in the system of connected devices 100. In general, external device 106 may be any suitable device separate and apart from appliances (e.g., such as kitchen appliance 102 and refrigerator appliance 104) that is configured to provide and/or receive communications, information, data, or commands from a user. In this regard, external device 106 may be an additional user interface to the user interface panels of the various appliances within the system of connected appliances 100. In this regard, for example, the external device 106 may be a personal phone, a smartphone, a tablet, a laptop or personal computer, a wearable device, a smart home system, or another mobile or remote device. For example, the separate device may be a smartphone operable to store and run applications, also known as “apps,” and the remote external device 106 be provided as a smartphone app.

In addition, as will be described in more detail below, the system of connected appliances 100 may include or be communicatively coupled with a remote server 108 that may be in operative communication with external device 106 and/or some or all appliances within system of connected appliances 100. Thus, user interface device 106 and/or remote server 108 may refer to one or more devices that are not considered household appliances as used herein. In addition, devices such as a personal computer, router, network devices, and other similar devices whose primary functions are network communication and/or data processing are not considered household appliances as used herein.

As illustrated, each of kitchen appliance 102 and refrigerator appliance 104, or any other devices or appliances in system of connected appliances 100, may include or be operably coupled to a controller, as identified herein, kitchen appliance controller 110 and refrigerator controller 111. References and description of controllers 110, 111 in the singular apply to controllers 110, 111 in the plural unless context clearly indicates otherwise. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controllers 110, 111 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controllers 110, 111 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controllers 110, 111 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controllers 110, 111 as disclosed herein are capable of and may be operable to perform any methods, method steps, or portions of methods as disclosed herein. For example, in some embodiments, methods disclosed herein may be embodied in programming instructions stored in the memory and executed by controllers 110, 111. The memory devices may also store data that can be retrieved, manipulated, created, or stored by the one or more processors or portions of controllers 110, 111. The data can include, for instance, data to facilitate performance of methods described herein. The data can be stored locally (e.g., on the controllers 110, 111) in one or more databases and/or may be split up so that the data is stored in multiple locations. In addition, or alternatively, the one or more database(s) can be connected to controllers 110, 111 through any suitable communication module, communication lines, or network(s). In this regard, for example, controllers 110, 111 may further include a communication module or interface that may be used to communicate with one or more other component(s) of kitchen appliance 102, refrigerator appliance 104, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring still to FIG. 1, a schematic diagram of an external communication system 112 will be described according to an exemplary embodiment of the present subject matter. In general, external communication system 112 is configured for permitting interaction, data transfer, and other operative communication between and among kitchen appliance 102, refrigerator appliance 104, external device 106, remote server 108, other appliances within system of connected appliances 100, and/or one or more external devices. For example, this communication may be used to provide and receive operating parameters, cycle settings, user instructions or notifications, performance characteristics, user preferences, or any other suitable information for improved performance of one or more appliances within system of connected appliances 100. In addition, it should be appreciated that external communication system 112 may be used to transfer data or other information to improve performance of one or more external devices or appliances and/or improve user interaction with such devices.

In addition, remote server 108 may be in communication with an appliance and/or external device 106through a network 114. In this regard, for example, remote server 108 may be a cloud-based server 108, and is thus located at a distant location, such as in a separate state, country, etc. According to an exemplary embodiment, external device 106 may communicate with a remote server 108 over network 114, such as the Internet, to transmit/receive data or information, provide user inputs, receive user notifications or instructions, interact with or control the appliance, etc. In addition, external device 106 and remote server 108 may communicate with the appliance to communicate similar information.

In general, communication between an appliance, external device 106, remote server 108, and/or other user devices or appliances may be carried using any type of wired or wireless connection and using any suitable type of communication network, non-limiting examples of which are provided below. For example, external device 106 may be in direct or indirect communication with the appliance through any suitable wired or wireless communication connections or interfaces, such as network 114. For example, network 114 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 112 is described herein according to an exemplary embodiment of the present subject matter. However, it should be appreciated that the exemplary functions and configurations of external communication system 112 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

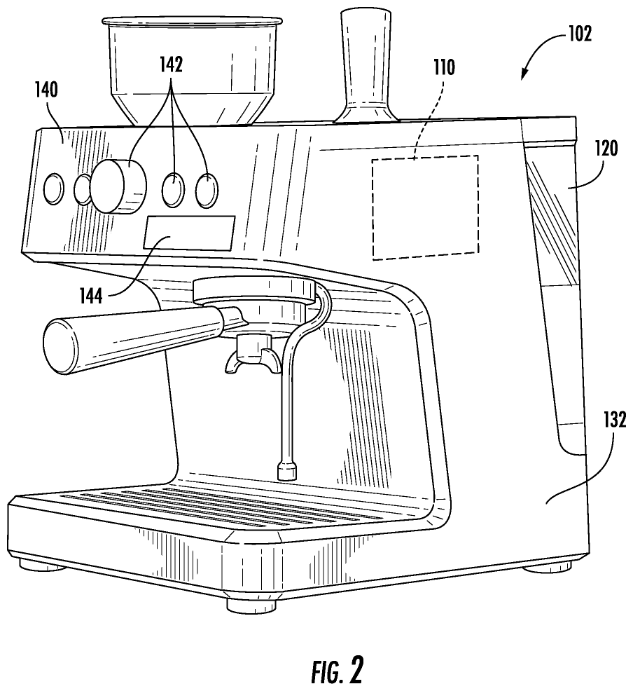

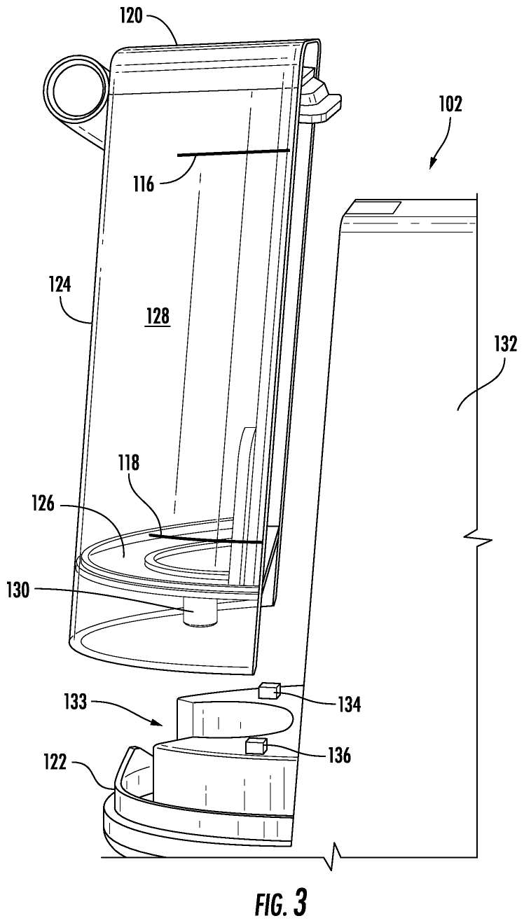

Referring now to FIGS. 2 and 3, kitchen appliance 102 will be described according to an exemplary embodiment of the present subject matter. For purposes of this disclosure, kitchen appliance 102 may be any kitchen appliance that consumes water and requires periodic manual refilling. As depicted and described throughout, kitchen appliance 102 can be a brewed beverage maker, for example an espresso maker. In general, kitchen appliance 102 has a removable water container 120 that can be removed from the kitchen appliance 102 and manually filled with water. The water container comprises a wall 124 formed with or attached to a bottom 126, the wall 124 and bottom 126 defining an interior volume 128. The water container 120 may include markings indicating the maximum prescribed water level 116 for the water container and a similar marking identifying a minimum water level 118. A valve assembly 130 provides controlled access between the interior volume 128 and the kitchen appliance body 132. The body 132 contains components facilitating the operation of the kitchen appliance, for example heaters, pumps, valves, and the like.

The body 132 also includes a base 122 configured to receive water container 120 and secure it to the kitchen appliance 102. The base 122 includes a receiver 133 that accepts the valve and selectively opens it to allow water to flow from the interior volume 128 to into the body 132 for processing into a brewed beverage. The body 132 also includes a presence detector 134 for detecting the presence of the water container in the base 122. A fluid level sensor 126 is included on the body 132 and configured to continuously, or substantially continuously, monitor the fluid level inf the water container 102. In the exemplary embodiment of FIG. 3, the presence detector 134 and fluid level sensor 136 are provided on the base 122 for ease of illustration only. The presence detector 134 and fluid level sensor 136 may be located anywhere in or on the kitchen appliance that provides access to the water container 120 to facilitate presence detection and sense the fluid level in the water container, respectively.

Referring again to FIG. 2, kitchen appliance 102 may include a control panel 140 that may represent a general-purpose Input/Output (“GPIO”) device or functional block for kitchen appliance 102. In some embodiments, control panel 140 may include or be in operative communication with one or more user input devices 142, such as one or more of a variety of digital, analog, electrical, mechanical, or electro-mechanical input devices including rotary dials, control knobs, push buttons, toggle switches, selector switches, and touch pads. Additionally, appliance 102 may include a display 144, such as a digital or analog display device generally configured to provide visual feedback regarding the operation of appliance 102. For example, display 144 may be provided on control panel 140 and may include one or more status lights, screens, or visible indicators. According to exemplary embodiments, user input devices 142 and display 144 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

As above, kitchen appliance 102 may include or be in operative communication with a processing device or a controller 110 that may be generally configured to facilitate operation of the kitchen appliance. In this regard, control panel 140, user input devices 142, and display 144 may be in communication with controller 110 such that controller 110 may receive control inputs from user input devices 142, may display information using display 144, and may otherwise regulate operation of appliance 102. For example, signals generated by controller 110 may operate appliance 102, including any or all system components, subsystems, or interconnected devices, in response to the position of user input devices 142 and other control commands. Control panel 140 and other components of appliance 102 may be in communication with controller 110 via, for example, one or more signal lines or shared communication busses. In this manner, Input/Output (“PO”) signals may be routed between controller 110 and various operational components of appliance 102.

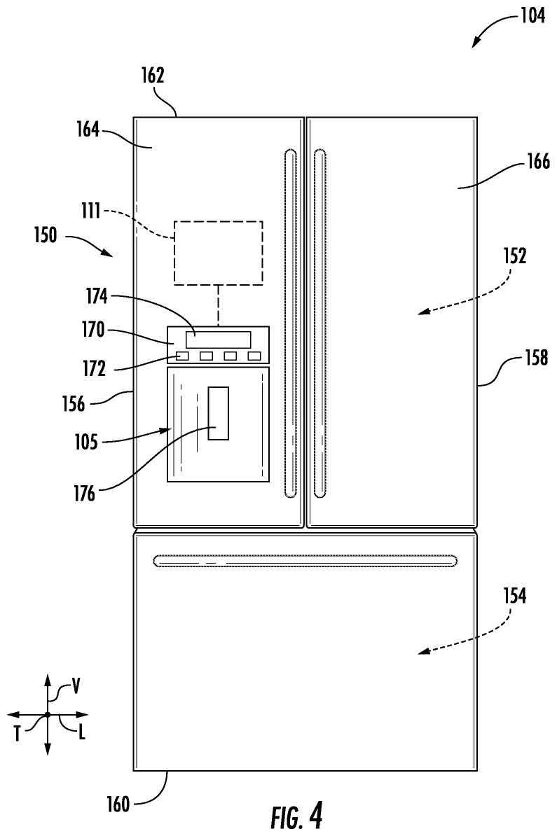

Referring to FIGS. 1 and 4, refrigerator appliance 104 will be described according to an exemplary embodiment of the present subject matter. Refrigerator appliance 104 includes a housing or cabinet 150 defining a vertical direction V, a lateral direction L, and a transverse direction T, with the vertical, lateral, and transverse directions being mutually perpendicular. The cabinet extends laterally from a first (left) side 156 to a second (right) side 158 and vertically from a bottom 160 to a top 162.

The cabinet 150 defines a fresh food chamber 152 and one or more frozen food storage chambers, such as a frozen food storage chamber 154 arranged below fresh food chamber 152 along the vertical direction V. In this configuration, refrigerator appliance 104 may generally be referred to as a bottom mount, or bottom freezer, refrigerator. In the exemplary embodiment of FIGS. 1 and 4, controlled access to fresh food chamber 152 is provided by first (left) door 164 and second (right) door 166, each supported at opposite sides of the cabinet for rotation between a closed position as illustrated and an open position (not shown). This configuration may be referred to as a French door refrigerator. Accordingly, the exemplary refrigerator appliance 104 may be referred to as a French door bottom mount refrigerator appliance. It will be appreciated that the present subject matter can be used with other types of refrigerator appliances as well, such as single door bottom mount refrigerator appliances. Consequently, the description set forth herein is not intended to limit the present subject matter in any aspect.

As above, refrigerator appliance 104 may include or be in operative communication with a processing device or a controller 111 that may be generally configured to facilitate operation of the refrigerator appliance 104. In this regard, refrigerator control panel 170, user input devices 172, and display 174 may be in communication with refrigerator controller 111 such that controller 111 may receive control inputs from refrigerator user input devices 172, may display information using display 174, and may otherwise regulate operation of refrigerator appliance 104. For example, signals generated by controller 111 may operate refrigerator appliance 104, including any or all system components, subsystems, or interconnected devices, in response to the position of user input devices 172 and other control commands. Control panel 170 and other components of refrigerator appliance 104 may be in communication with controller 111 via, for example, one or more signal lines or shared communication busses. In this manner, Input/Output (“I/O”) signals may be routed between controller 111 and various operational components of refrigerator appliance 104.

In the illustrative embodiments of FIGS. 1 and 4, refrigerator appliance 104 includes a door-mounted water/ice dispenser, dispensing system 105 located in first door 164. Water dispensing system 105 may include a receptacle to receive the water container 120, a fill tube to introduce water to the container, tubing, flow meters, valves timers, etc. to direct the flow, and at least one sensor, for example dispensing sensor 176 to detect the presence of a container and control flow.

In other embodiments, the dispensing system 105 may be located in the second door 166, or in the one door of a single door refrigerator appliance. The water dispensing system 105 may be operatively coupled to the control panel 170 and controller 111 to receive operating instructions. For example, manipulation of user input devices 172 may instruct the operation of water dispensing system 105 regarding the form of water to be dispensed (e.g., water, cubed ice, or crushed ice). Dispensing system 105 may include a sensor 176 configured to initiate the dispensing of the selected water form when the sensor 176 detects the presence of a container. The sensor 176 may control the amount of, for example, water dispensed by starting the dispensing when the sensor 176 is triggered and stopping the dispensing when the container is moved within the water dispensing system 105 or removed from the dispenser.

In some embodiments, the refrigerator controller 111 may receive communication from another connected appliance, for example the kitchen appliance 102, to place the water dispensing system 105 in a refill mode to dispense a certain predetermined refill volume of water upon the next activation of the sensor 176, provided that the next activation occurs within a predetermined time period. For example, the controller 110 for kitchen appliance 102 may detect a low water level in the water container 120 and determine the volume of water necessary to return the water container to a prescribed fluid level. The kitchen appliance may signal the user, for example via the external device 106, of the low level in the container 120 and request confirmation that the refrigerator appliance 104 will be used to refill the container 120 to a prescribed or predetermined fluid level. Upon receipt of the confirmation, the kitchen appliance controller may signal the refrigerator controller 111, providing information on the volume of water to be dispensed upon the next activation of the sensor 176. At that next activation, controller 111 instructs the water dispenser system 105 to dispense the predetermined volume of water. Once the predetermined volume of water is dispensed, refrigerator controller 111 instructs the dispenser system 105 to exit the refill mode to return to the normal mode of operation. Alternately, if the dispensing sensor 176 is not activated in a prescribed time period, the dispenser returns to its normal operation. Accordingly, the refrigerator appliance controller is configured to remove the water dispensing system 105 from the refill mode at the first to occur of completion of the dispensing of the predetermined volume of water (i.e., at the completion of the refill mode) and the expiration of the prescribed time period.

The exemplary system of connected appliances 100 comprises a kitchen appliance 102 and a refrigerator appliance 104 commissioned on the same user account such that the connected appliance can communicate, directly through direct communication link 119 or indirectly through external communication system 112.

Now that the construction of system of connected appliances 100, kitchen appliance 102, refrigerator appliance 104, and external communication system 112 have been presented according to exemplary embodiments, an exemplary method 200 of operating a system of household appliances will be described. Although the discussion below refers to the exemplary method 200 of operating system of connected appliances 100, one skilled in the art will appreciate that the exemplary method 200 is applicable to the monitoring, control, utilization, or interconnectivity of any suitable number, type, and configuration of appliances. In exemplary embodiments, the various method steps as disclosed herein may be performed by one or more controllers (e.g., such as controllers 110, 111) or by a separate, dedicated controller that may be located locally on one or more of the appliances, remotely on a remote server, etc.

The exemplary method of operation 200 begins at step 202 at which the fluid level in a water container 120 for a kitchen appliance 102 is monitored. In embodiments, the water level is continuously monitored using a fluid level sensor 136 component of the kitchen appliance 102. In other embodiments, the fluid level sensor 136 may be part of the water container 120. In still other embodiments, the fluid level sensor may have a component in the water container 120 and a component in the kitchen appliance 102. The fluid level sensor 136 senses the fluid level in the water container 120 and communicates the low fluid level to the kitchen appliance controller 110. Additionally or alternatively, the fluid level sensor 136 may communicate the low water level through the appliance controller 110 to the external device 106 to alert a user that the water level is at or below a prescribed minimum, i.e. a water level at or below the minimum fill line 118.

At 204, the removal of the water container 120 from the kitchen appliance 102 is detected by the presence detector 134. The presence detector 134 may be part of the kitchen appliance 102, part of the water container 120, or may have a component in the water container 120 and a component in the kitchen appliance 102. In normal operation, the presence detector 134 detects the presence of the water container 120 in the base 122 or otherwise accepted in the kitchen appliance 102. When a low water level is detected, as in step 202, and the water container 120 is removed from the kitchen appliance 102, the controller 110 may communicate the water container removal to an external device 106 according to embodiments of the present disclosure. The communication to the external device 106 may include a request for permission to communicate the refill volume to the refrigerator appliance 104. In order to proceed, a confirming user input may be required on the external device 106, wherein the permission includes user input. The confirming input may include identification and selection of one refrigerator appliance from a plurality of refrigerator appliances (or any other suitable water dispensing appliance) commissioned on the same user account and selection and confirmation of the refill volume (i.e., confirmed refill volume) to be supplied by the water dispensing system 105. Removal of the water container 120 may also be communicated to the network 114 wherein the network 114 begins a search for a refrigerator commissioned on the same user account as the kitchen appliance 102.

In some embodiments, the water level and the water container removal are not communicated to the external device 106. Instead, the removal of the water container 120 is communicated to the kitchen appliance controller 110 and to the network 114. As above, the network 114 may begin a search for a refrigerator commissioned on the same user account as the kitchen appliance 102, here without seeking confirmation from the external device 106.

At step 206, the kitchen appliance controller 110 performs a determination of a refill volume sufficient to return the water level in the water container 120 to a prescribed fluid level. The kitchen appliance controller 110 may perform the determination with the water container 120 accepted into the base 122. Fluid level sensor 136 continuously monitors the fluid level in the water container 120 and may communicate the fluid level to the controller 110 periodically or whenever there is a change in fluid level. Therefore, the controller 110 may determine the refill volume at least periodically or whenever there is a change in the fluid level. The controller may use the known pitcher volume corresponding to the predetermined fluid level (for example the maximum volume at the maximum fill line 116) and subtract a known or calculated volume corresponding to the monitored fluid level or water level at the time the water container was removed from the kitchen appliance 102 to determine the volume of fluid to be added. In embodiments in which the external device 106 receives the low fluid level alert, the confirming input may include a confirmation of the determined refill volume or an option to fill the water container 120 to a level less than the level corresponding to the maximum fill line 116 (i.e., less that the maximum fluid level). In such a case, the user input refill level is controlling and the refill volume determined will fill the water container 120 to a fluid level less than the maximum fill line 116.

At step 208, the kitchen appliance controller 110 communicates the refill volume determined at 206 to the refrigerator appliance controller 111. Communication of the refill volume may be through direct communication link 119 or through the external communication system 112. The refrigerator appliance controller 111 signals the water dispensing system 105 to dispense the fluid volume necessary to fill the water container to the predetermined level (e.g., maximum fill level or a user input refill level) upon the next activation of the dispensing sensor 176.

In some embodiments, more than one refrigerator appliance 104 may be commissioned on the same user account as the kitchen appliance 102. In those cases, confirming input at the external device 106 may include user selection of the desired refrigerator appliance. In cases in which the user makes the same refrigerator selection for a predetermined number of times, a rules engine, for example a rules engine in the network 114 or in the external device 106, may select the user-chosen refrigerator appliance as the default refrigerator. The user, through input on the external device, may prevent the rules engine from making a default selection, or may change the selection.

According to some embodiments, the network 114 may be in operative communication with at least the kitchen appliance 102 and the refrigerator appliance 104 through communication channels discussed above. For example, the network 114 may receive notification from the fluid level sensor 136 of a low fluid level in the water container 120 (i.e., a level at or below the minimum fill line 118). The fluid level sensor 136 continuously monitors the fluid level in the water container 120 and communicates a low fluid level to the appliance controller 110. The controller 110 then communicates to the low fluid level to the network 114.

The network 114 may also receive notification from a presence detector 134 on the kitchen appliance 102 indicating that the water container 120 has been removed from the kitchen appliance 102. The presence detector 134 senses the presence of the water container 120 received in the base 122 of the kitchen appliance 102. The signal corresponding to a removed (i.e., not present) water container 120 may be sent to the appliance controller 120. In embodiments, if the controller recognizes the water container 120 is removed after a low fluid level was sensed after the fluid level sensor 136 sensed a low level, the appliance controller 110 may send a corresponding notification to the network 114.

The kitchen appliance controller 110 may calculate a water volume to return the water level in the water container 120 to a predetermined level, for example a level corresponding to the maximum fill line 116. The controller 110 may subtract the volume of water corresponding to the low fluid level sensed above from the volume corresponding to the predetermined level (e.g., the maximum fill line 116) in determining the volume required to reach the predetermined level. The network 114 may receive the refill volume to return the water container to a predetermined fluid level from the kitchen appliance 102, specifically from the appliance controller 110.

The network 114 may then identify a refrigerator appliance from one or more refrigerator appliances commissioned on a same user account as the kitchen appliance 102. In cases in which there are more than one refrigerator appliance commissioned to the same user account, the network may send a message to the external device 106 requesting user confirmation of the refrigerator appliance to be used for water dispensing. User confirmation may include confirmation of the fluid level or liquid volume to be dispensed as well. Confirmation may be achieved through user entry of commands through the external device 106.

Upon identification of the refrigerator appliance 104, the network 114 may communicate the refill volume to a water dispensing system 105 of the refrigerator appliance. As shown in the exemplary embodiments of FIGS. 1 and 4, the water dispensing system 105 may be located on the outside of first door 164 to the fresh food storage chamber 154. In other embodiments, the water dispensing system 105 may be located on the outside of second door 166, on the inside of first or second door 164, 166, or within the refrigerator cabinet 150.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A kitchen appliance commissioned on a same user account with a refrigerator appliance comprising a water dispensing system, the kitchen appliance comprising:
a removable water container defining a maximum fluid level;
a presence detector for the water container;
a fluid level sensor configured to detect a fluid level in the water container; and
an appliance controller in operative communication with the presence detector and the fluid level sensor, wherein the appliance controller is configured to:
monitor a fluid level in the water container using the fluid level sensor;
detect removal of the water container using the presence detector;
determine a refill volume to return the fluid level in the water container to a prescribed fluid level; and
communicate the refill volume to the water dispensing system of the refrigerator appliance.

2. The kitchen appliance of claim 1, wherein the appliance controller is further configured to communicate a low water level to an external device when the fluid level sensor senses a fluid level below a prescribed minimum.

3. The kitchen appliance of claim 1, wherein the appliance controller is further configured to:
communicate the removal of the water container to an external device; and
request permission to communicate refill volume to the refrigerator, wherein permission includes user input on the external device.

4. The kitchen appliance of claim 3, wherein user input includes identification of the refrigerator and confirmation of refill volume.

5. The kitchen appliance of claim 4, wherein the confirmed refill volume returns the fluid level in the water container to a level less than maximum fluid level.

6. The kitchen appliance of claim 5, wherein the confirmed refill volume is determined by the appliance controller from a predetermined fluid level and the monitored fluid level at a time the water container was detected to be removed from the kitchen appliance.

7. The kitchen appliance of claim 3, wherein user input on the external device includes selection of the refill volume.

8. The kitchen appliance of claim 4, wherein identification of the refrigerator includes selection of one refrigerator from a plurality of refrigerators commissioned on the same account.

9. The kitchen appliance of claim 1, wherein the appliance controller is further configured to place the water dispensing system in a refill mode to dispense the refill volume upon activation of the water dispensing system within a prescribed time period.

10. The kitchen appliance of claim 1, further comprising an external communication system in operative communication with the kitchen appliance and the refrigerator appliance.

11. The kitchen appliance of claim 10, wherein the appliance controller is further configured to communicate the refill volume to the refrigerator appliance through the external communication system.

12. A method of operating a kitchen appliance and a refrigerator appliance from a network, the method comprising:
receive notification from a fluid level sensor on a kitchen appliance of a low fluid level;
receive notification from a presence detector on the kitchen appliance of a removal of a water container from the kitchen appliance;
receive from the kitchen appliance a refill volume to return the water container to a predetermined fluid level;
identify a refrigerator appliance from one or more refrigerator appliances commissioned on a same user account as the kitchen appliance; and
communicate the refill volume to a water dispensing system of the refrigerator appliance.

13. A method of operating a kitchen appliance commissioned on a same user account with a refrigerator appliance, the refrigerator appliance comprising a water dispensing system, the kitchen appliance comprising a removable water container defining a maximum fluid level, a presence detector for the water container, and a fluid level sensor configured to detect a fluid level in the water container, the method comprising:
monitoring a fluid level in the water container using the fluid level sensor;
detecting removal of the water container using the presence detector;
determining a refill volume to return the fluid level in the water container to a prescribed fluid level; and
communicating the refill volume to the water dispensing system of the refrigerator appliance.

14. The method of claim 13, further comprising communicating a low water level to an external device when the fluid level sensor senses a fluid level below a prescribed minimum.

15. The method of claim 13, further comprising:
communicating the removal of the water container to an external device; and
requesting permission to communicate refill volume to the refrigerator, wherein permission includes user input on the external device.

16. The method of claim 15, wherein user input includes identification of the refrigerator and confirmation of refill volume.

17. The method of claim 16, further comprising determining the confirmed refill volume from a predetermined fluid level and the monitored fluid level at a time the water container was detected to be removed from the kitchen appliance.

18. The method of claim 16 wherein identification of the refrigerator includes selection of one refrigerator from a plurality of refrigerators commissioned on the same account.

19. The method of claim 13, further comprising an external communication system in operative communication with the kitchen appliance and the refrigerator.

20. The method of claim 19, wherein the appliance controller is further configured to communicate the refill volume to the refrigerator through the external communication system.
